(19) United States
(12) Patent Application Publication
(10) Pub. No.: US 2025/0181036 A1
(43) Pub. Date: Jun. 5, 2025

(54) REGULATING SYSTEM FOR A TIMEPIECE

(71) Applicant: ROLEX SA, Geneva (CH)

(72) Inventors: François Barrot, Erlach (CH); Fabiano Colpo, Lausanne (CH); Fabien Droz, Thielle (CH); Pierre-Alain Koller, Versoix (CH); Grégory Musy, Le Mont-Sur-Lausanne (CH); Romain Sumi, Marin-Epagnier (CH)

(73) Assignee: ROLEX SA, Geneva (CH)

(21) Appl. No.: 18/961,765

(22) Filed: Nov. 27, 2024

(30) Foreign Application Priority Data
Nov. 30, 2023 (EP) 23213488.2

(51) Int. Cl. G04C 3/10

(52) U.S. Cl. CPC G04C 3/108; G04C 3/102

(57) ABSTRACT

The regulating system includes a mechanical first oscillator (100) designed to regulate at least partly a train (82) of a timepiece movement (2000) driven by a drive system (81), a device (600) configured to impose a main operating mode in which the mechanical first oscillator (100) oscillates at a first predetermined frequency (f1), the control device (600) being controlled by a train (82) at least partly regulated by the first oscillator (100), and an actuator device (500) configured to command passage to an auxiliary operating mode in which the mechanical first oscillator (100) oscillates at another predetermined frequency (f2, f3) different from the first frequency (f1).

### CROSS-REFERENCE TO RELATED APPLICATION

This application claims priority of European patent application No. EP23213488.2 filed Nov. 30, 2023, the content of which is hereby incorporated by reference herein in its entirety.

### FIELD OF THE INVENTION

The invention concerns a regulating system for a timepiece. The invention also concerns a timepiece movement comprising such a regulating system. The invention further concerns a timepiece comprising such a timepiece movement or such a regulating system. The invention finally concerns a method of operating such a regulating system.

### BACKGROUND ART

Even on automatic watches having good chronometric accuracy there remains a preoccupation with improving the rate. By “rate” we mean the expression of a difference per unit time between two states of a timepiece separated by a given time interval, and a “state” can be defined as being a difference at a precise moment between the time indicated by the timepiece and the time indicated by a reference clock. These definitions conform to those given in the standard ISO 6426-2 (respectively under heads 5.2 and 5.1).

The application EP1158373 discloses a balance & balance spring type oscillator in which the exterior end of the balance spring can be actuated by a motor to modify the active length of the balance spring in order to slow down or to accelerate the oscillator. This document describes an error detection system disposed at the level of the escapement anchor (in particular by means of a piezoelectric detent pin), which compares the effective frequency of the escapement and that of a third-party timebase. Depending on the result, the motor associated with an error adjustment system will turn in a first sense or a second sense in order to shorten or to lengthen the active length of the balance spring. The intervention on the balance spring may be effected hourly or daily.

The application EP1164441 describes a concept equivalent to that known from the application EP1158373 but with a very different implementation. Here the error detection system is in the finishing train and more particularly comprises a contactor disposed on a center mobile effecting one turn in one hour and on which is mounted a minute hand. Thus, error detection can take place every hour.

In a first embodiment the electromechanical device is capable only of correcting an advance of the rate of the movement. To this end the device immobilizes the escape wheel for a time interval corresponding to said advance.

The second embodiment for its part has the advantage of enabling correction of an advance or a delay of the rate of the timepiece, as is the case in the movement known from the application EP1158373. To this end the second embodiment comprises a device enabling action on the active length of the balance spring by way of a piezoelectric element disposed at the level of the exterior end of the balance spring. The latter can be actuated in a first sense or a second sense in order to shorten or to lengthen the active length of the balance spring.

Also known from the documents CH6444 and CH321947 are index assemblies moveable incrementally. The active length of the balance spring can be selected from a plurality of predetermined lengths because of the effect of an action of the wearer of the watch.

### SUMMARY OF THE INVENTION

The aim of the invention is to improve known regulating systems. The invention proposes in particular a simple and reliable regulating system making it possible to improve the accuracy of timepiece movements.

A regulating system according to the invention is defined by point 1 below.
1. A regulating system wherein the regulating system comprises:
   a mechanical first oscillator designed to regulate at least partly a train of a timepiece movement driven by a drive system,
   a control device configured to impose a main operating mode in which the mechanical first oscillator oscillates at a first predetermined frequency, the control device being controlled by a train at least partly regulated by the first oscillator, and
   an actuator device configured to command passage to an auxiliary operating mode in which the mechanical first oscillator oscillates at another predetermined frequency different from the first frequency.

Embodiments of the regulating system are defined by points 2 to 8 below.
2. The system as defined in point 1 wherein the regulating system comprises a frequency selector device and the control device and/or the actuator device act(s) on a frequency selector device configured so as to define three oscillation frequencies, as follows:
   the first frequency,
   a second frequency lower than the first frequency, and
   a third frequency higher than the first frequency.
3. The regulating system as defined in point 1 or 2 wherein the mechanical first oscillator comprises an inertial element and an elastic return system and the various frequencies are defined by various predetermined stiffnesses of the elastic return system.
4. The regulating system as defined in point 3 wherein the selector device comprises a pair of clamps determining an active length, in particular three active lengths, of the elastic return system.
5. The regulating system as defined in any one of the preceding points and as defined in point 2 wherein the actuator device acting on the selector device is controlled by the control device.
6. The regulating system as defined in any one of the preceding points wherein the regulating system comprises a comparator device adapted to compare a period of rotation of a mobile of a finishing train and a reference rotation period of said mobile.
7. The regulating system as defined in any one of the preceding points wherein the regulating system comprises a counting device including a second oscillator with a fourth frequency greater than the first frequency.
8. The regulating system as defined in the preceding point wherein the regulating system comprises a device for initializing the counting device configured to be activated by an adjustment mechanism of a display device of a timepiece.

A timepiece movement according to the invention is defined by point 9 below.
9. A timepiece movement comprising a regulating system as defined in any one of the preceding points and a train, in particular a finishing train.

A timepiece according to the invention is defined by point 10 below.
10. A timepiece, in particular a wristwatch, comprising a regulating system as defined in any one of points 1 to 8 and/or a movement as defined in the preceding point.

A method of operation according to the invention is defined by point 11 below.
11. A method of operating a regulating system for a timepiece movement, the regulating system comprising a mechanical first oscillator designed to regulate at least partly a train of a timepiece movement driven by a drive system, the method comprising at least one iteration of the following steps:
   a first step of operating in a main operating mode in which the mechanical first oscillator oscillates at a predetermined first frequency,
   a second step in which an actuator device modifies the frequency of the mechanical first oscillator,
   a third step of operating in an auxiliary operating mode in which the mechanical first oscillator oscillates at a second frequency or at a third frequency,
   a fourth step in which a control device imposes a return to the main operating mode, this control device being controlled by the train at least partly regulated by the first oscillator.

Embodiments of the method of operation are defined by points 12 to 16 below.
12. The operating method as defined in the preceding point wherein the method comprises:
   a step of comparing the time displayed by a timepiece movement and a reference time, and
   execution of the second, actuation step in the event of a particular threshold being exceeded during the comparison step.
13. The operating method as defined in the preceding point wherein the comparison step is carried out at a regular time interval and/or at an interval defined by a timepiece movement.
14. The operating method as defined in point 12 or 13 wherein the comparison step occurs at the request of the user.
15. The operating method as defined in any one of points 11 to 14 wherein the fourth step occurs at a regular time interval and/or at an interval defined by a timepiece movement.
16. The operating method as defined in any one of points 11 to 15 wherein the second step is a step of moving a pair of immobilization clamps along an elastic blade and/or the fourth step is a step of moving a pair of immobilization clamps along an elastic blade.

### BRIEF DESCRIPTION OF THE DRAWINGS

The appended drawings represent by way of example one embodiment of a timepiece according to the invention.

FIG. 1 is a schematic view of one embodiment of a timepiece according to the invention.

FIG. 2 is a front view of a first oscillator of said embodiment of the timepiece according to the invention.

FIG. 3 is a view of said embodiment of the timepiece showing a finishing train.

FIG. 4 is a view of said embodiment of the timepiece showing a detail of a stiffness selector device.

FIG. 5 is a view of said embodiment of the timepiece showing the integration of the stiffness selector device.

FIG. 6 is a view of said embodiment of the timepiece depicting three configurations of the stiffness selector device, namely:

FIG. 6a represents the selector device in a first position in relation to a tooth structure,

FIG. 6b represents the selector device in a second position in relation to the tooth structure, and

FIG. 6c represents the selector device in a third position in relation to the tooth structure.

FIG. 7 is a view of said embodiment of the timepiece showing the integration of an actuation device.

FIG. 8 is a flowchart depicting the operation of a timepiece according to the invention.

FIG. 9 is a view of said embodiment of the timepiece showing the integration of a comparator device.

FIG. 10 is a view of said embodiment of the timepiece showing the integration of a control device.

FIG. 11 is a view of said embodiment of the timepiece showing a detail of the integration of the control device.

FIG. 12 is a flowchart depicting the method of operating the regulating system according to the invention.

### DETAILED DESCRIPTION OF PARTICULAR EMBODIMENTS

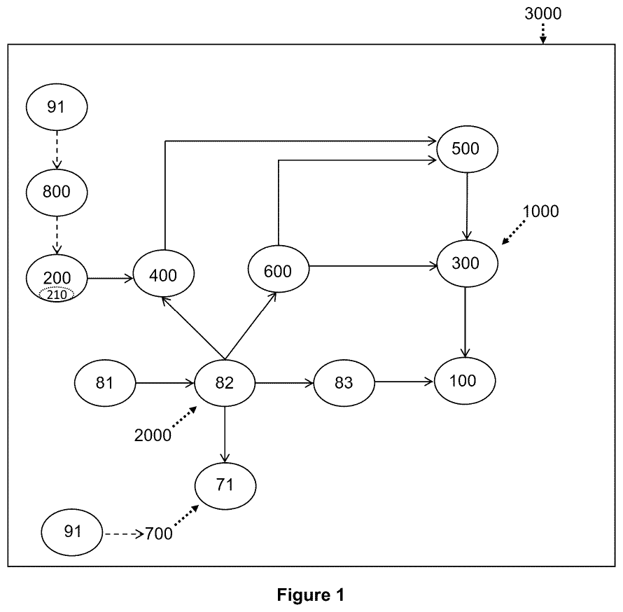

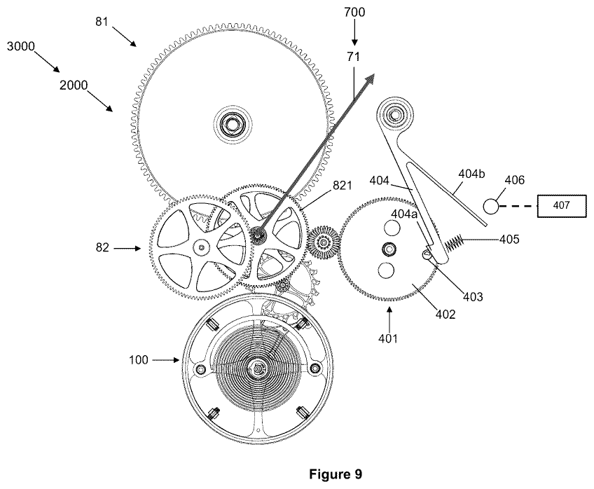

One particular embodiment of a timepiece 3000 is described in detail hereinafter with reference to FIGS. 1 to 12.

The timepiece 3000 is for example a watch, in particular a wristwatch. The timepiece 3000 comprises a timepiece movement 2000 intended to be mounted in a timepiece casing in order to protect it from the external environment.

The timepiece movement 2000 is a mechanical movement, in particular an automatic movement, or a hybrid movement.

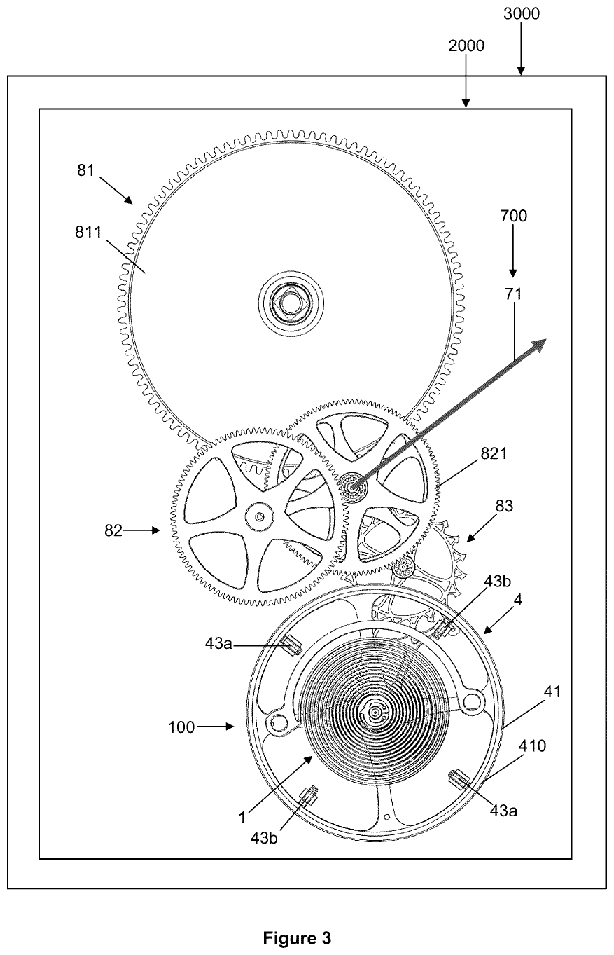

The timepiece movement 2000 comprises:
an oscillator 100,
an escapement system 83,
a finishing train 82, and
a drive system 81 including a drive member 811 such as a barrel 811 as represented in FIG. 3.

The first oscillator 100 enables regulation, in particular by way of an escape system 83, of the driving of the finishing train 82, which is actuated by the effect of the drive system 81. In particular, this first oscillator 100 enables regulation of the driving of a mobile 821 on which is mounted a display element 71, such as a hand 71 of a display device 700 of the timepiece 3000. The mobile 821 is for example a seconds mobile 821 on which is mounted a seconds hand 71.

The timepiece movement 2000 comprises a regulating system 1000.

The regulating system comprises:
the mechanical first oscillator 100 designed to regulate at least in part the train 82 of the timepiece movement 2000 driven by the drive system 81,
a control device 600 configured to impose a main operating mode in which the mechanical first oscillator 100 oscillates at a first predetermined frequency f1, the control device 600 being controlled by the train 82 at least partly regulated by the first oscillator 100, and
an actuator device 500 configured to command passage into an auxiliary operating mode in which the mechanical first oscillator 100 oscillates at another predetermined frequency f2, f3 different from the first frequency f1.

Here by “predetermined frequency” is meant a frequency determined in advance that is centered on a value f1 or f2 or f3. Each of these predetermined frequencies f1, f2, f3 can naturally vary over a given range the amplitude of which is a function of the tolerances of the system. So as to define a nominal frequency f1 of the first oscillator, the frequency f1 is preferably able to vary over a more restricted range, even a much more restricted range, than those associated with the frequencies f2, f3.

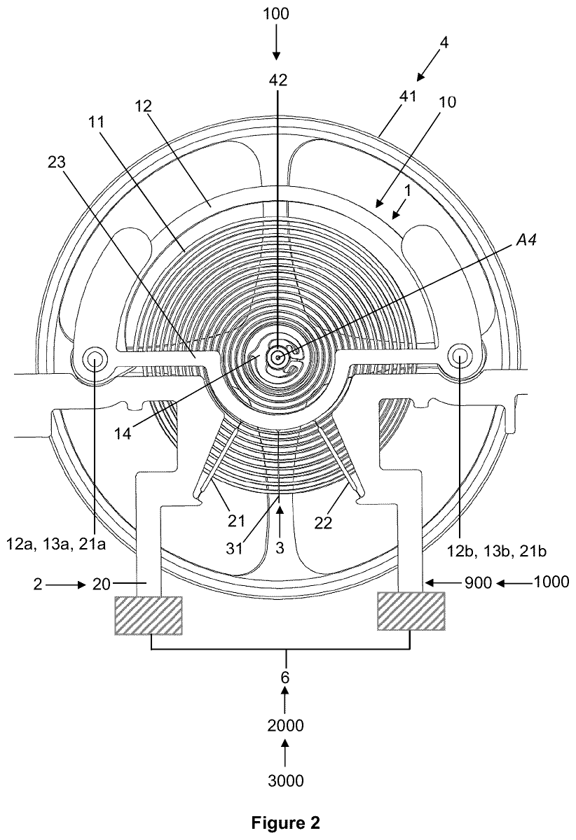

As depicted in FIG. 2, the first oscillator 100 advantageously comprises an oscillating mass 41 of an inertial element 4, in particular a balance, and a first elastic return element 1, in particular a balance spring. The first oscillator 100 further comprises a second elastic return element that is part of a support 2 of the first elastic return element 1.

The balance spring 1 is provided with a blade 11 of which:
a proximal first end 14 is connected to the oscillating mass 41 by a shaft 42 with geometric axis A4, and
a distal second end comprises a first connecting member 12 designed to be fixed to a second connecting member 23 of the support 2, in particular by means of tenons or pins 13a, 13b designed to be inserted in respective openings 12a, 12b and 21a, 21b formed on the first and second connecting members, respectively, in particular at each of their ends.

The second connecting member 23 is fixed to a rigid frame 20 by way of elastic blades 21, 22 each provided with flexible portions at their respective ends. Thus, the second elastic return element takes the form of the second connecting member 23 articulated on the body 20 by way of the elastic blades 21, 22.

For its part a third elastic return element 3 takes the form of a single elastic blade 31, which here is straight, that is fastened to the second connecting member 23 and is for example arranged between the elastic blades 21, 22 at the exterior periphery of the second connecting member 23.

In the embodiment described here, the elements 20, 21, 22, 23 of the support 2 and the blade 31 of the third elastic return element 3 form a monolithic structure 900 of the regulating system 1000, which is fastened to the frame 6 of the timepiece 3000, in particular of the movement 2000.

More generally, an elastic return system 10 of the first oscillator 100 therefore comprises first, second and third elastic return elements, the first elastic return element 1 and the second elastic return element 2 being mounted in series between the inertial element 4 and the frame 6 and the third elastic return element 3, and the second elastic return element 2 being mounted in parallel between said frame 6 and the first elastic return element 1.

In the embodiment described here, the stiffness selector device 300 of the elastic return system 10 enables selection of one of three predetermined stiffnesses ksr1, ksr2, ksr3:
the stiffness ksr1 inducing a nominal frequency f1 of the first oscillator 100,
the stiffness ksr2 being greater than the stiffness ksr1 and inducing a frequency f2 higher than the frequency f1, and
the stiffness ksr3 being less than the stiffness ksr1 and inducing a frequency f3 lower than the frequency f1.

Here by “predetermined stiffness” is meant a stiffness determined in advance that is centered on a value k1 or k2 or k3. Each of these predetermined stiffnesses k1, k2, k3 can naturally vary over a given range, the amplitude of which is a function of the tolerances of the system. So as to induce a nominal frequency f1 of the first oscillator, the stiffness k1 is preferably able to vary over a more restricted range, or even over a much more restricted range, than those associated with the stiffnesses k2, k3.

Thus, a stiffness ksr2 of the elastic return system 10 enables correction of a delay of the display device of the timepiece or correction of a delay of a mobile controlling a display device of the timepiece, if present, and a stiffness ksr3 of the elastic return system 10 enables correction of an advance of the display device of the timepiece or correction of an advance of a mobile controlling a display device of the timepiece, if present, as described hereinafter.

In the embodiment described here, the stiffness selector device 300 of the elastic return system 10 acts specifically on the stiffness of the third elastic return element 3, more particularly on the stiffness of the elastic blade 31. Thus, the stiffness selector device 300 enables selection of a particular stiffness of the third elastic return element 3 from the three predetermined stiffnesses k31, k32, k33, the stiffnesses ksr1, ksr2, ksr3 of the elastic return system 10 being respectively correlated with the stiffnesses k31, k32, k33. Thus, a stiffness k31 of the elastic blade 31 enables definition of a nominal frequency f1 of the first oscillator 100, a stiffness k32 of the elastic blade 31 enables correction of a delay of the display device of the timepiece or any delay of a mobile controlling a display device of the timepiece, if present, and a stiffness k33 of the elastic blade 31 enables correction of an advance of the display device of the timepiece or an advance of a mobile controlling a display device of the timepiece, if present, as described hereinafter.

It is apparent that such an arrangement of elastic return elements 1, 2, 3 with respective judiciously chosen stiffnesses k1, k2, k3 enables particularly fine adjustment of the rate. For example a variation of ±10% of stiffness k3 induces a variation of the rate of the timepiece comprising the first oscillator 100 equal or substantially equal to ±10 s/d.

Consequently, a rotation period P of the seconds mobile 821 is a function of the frequency of the first oscillator 100 and so the stiffness selector device 300 enables definition of said period P of the mobile 821.

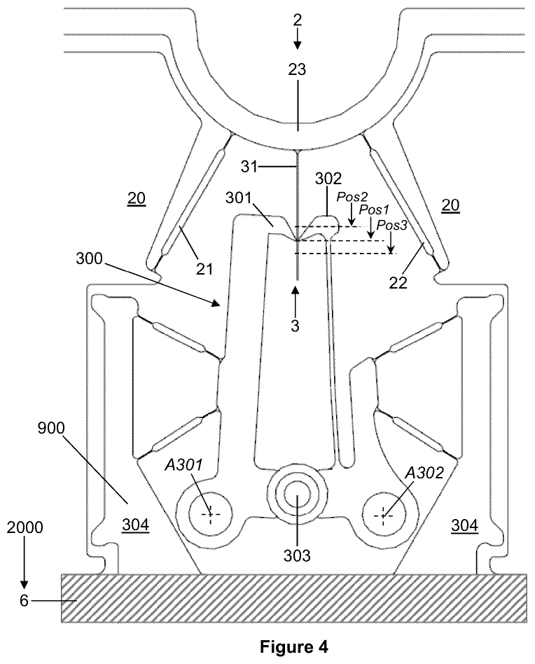

In the embodiment described here, the stiffness selector device 300 takes the form of a device for modifying the active length of the elastic blade 31 as depicted in FIG. 4. To this end, the device 300 comprises a pair of clamps 301, 302 gripping the elastic blade 31 and able to move in the longitudinal direction of said elastic blade 31 so as to reach three predefined stable positions Pos1, Pos2, Pos3 enabling definition of the stiffnesses k31, k32, k33, respectively.

Consequently, the selector device 300 may comprise a pair of clamps 301, 302 determining an active length, in particular three active lengths, of the elastic return system 10.

In this instance:
The position Pos1 enables definition of the rotation period P of the mobile 821 with a stiffness ksr1 of the elastic return system 10, in particular a stiffness k31 of the third elastic return element 3, and a nominal frequency f1 of the oscillator 100.
The position Pos2 enables reduction of the rotation period P of the mobile 821 with a stiffness ksr2>ksr1 of the elastic return system 10, in particular a stiffness k32>k31 of the third elastic return element 3, and a frequency f2>f1 of the oscillator 100. Thus, this position Pos2 enables the display element 71 to compensate a delay.
The position Pos3 enables increasing the rotation period P of the mobile 821 with a stiffness ksr3<ksr1 of the elastic return system 10, in particular a stiffness k32<k31 of the third elastic return element 3, and a frequency f3<f1 of the oscillator 100. Thus, this position Pos3 enables the display element 71 to compensate an advance.

Each of the clamps 301, 302 is advantageously mounted on the monolithic structure 900, in particular on a frame 304 of the monolithic structure 900, by way of elastic blades, and biased against the elastic blade 31 because of the effect of a tenon 303 that enables action against the elastic blades by loading the clamps 301, 302 substantially in pivoting about their respective rotation axes A301, A302. In particular the clamps 301, 302 are designed to clamp the elastic blade 31 with sufficient force to prevent mechanical play during oscillation of the oscillator. This force must nevertheless be determined so as to enable movement of the clamps 301, 302 from one stable position to another stable position. This force may typically be between 0.1 mN and 10 mN inclusive depending on the dimensions of the regulating system.

The selector system comprises:
the clamps 301, 302,
the tenon 303,
the frame 304,
a toothed structure 305,
a selector beak 306, and
a tenon 307.

The clamps 301, 302 can be retained in one or the other of the positions Pos1, Pos2, Pos3 thanks to the toothed structure 305 designed to position the selector beak 306 connected to the frame 304 by way of a flexible structure. In particular, the toothed structure 305 comprises three teeth recesses in which the beak 306 can be positioned because of the effect of the tenon 307 that enables loading of the flexible structure connecting the beak 306 to the frame 304 so as to retain said beak 306 in contact against the toothed structure 305.

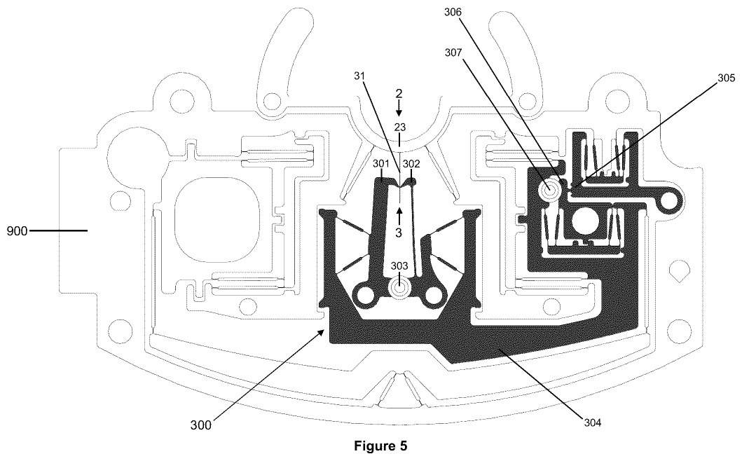

FIG. 5 represents the selector device 300 by way of illustration and using the color black. Here the device is part of the monolithic structure 900 designed to be mounted on the frame 6 of the movement 2000, in particular on an “ébauche”.

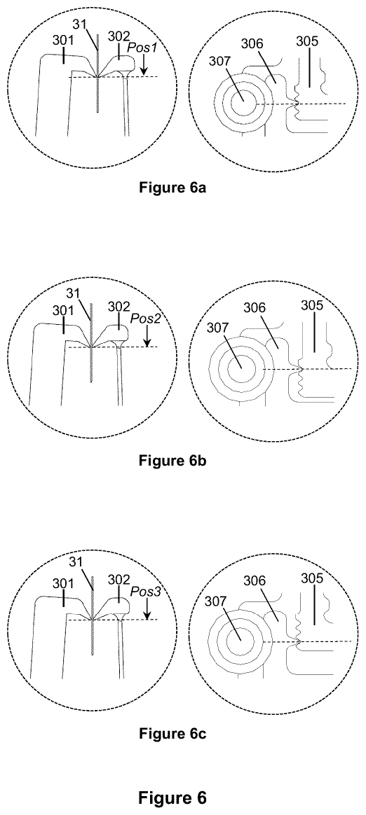

More generally, the selector device 300 therefore comprises at least one pair of clamps 301, 302 designed to act on the active length of the elastic blade 31 and a selector beak 306 cooperating with a toothed structure 305 that are designed to position the pair of clamps 301, 302 in one of the three stable positions Pos1, Pos2, Pos3 predefined by the teeth of the structure 305. FIG. 6 comprises:
a view 6a representing the selector device 300 in position Pos1,
a FIG. 6b representing the selector device 300 in position Pos2, and
a FIG. 6c representing the selector device 300 in position Pos3.

This selector device 300 is actuated periodically by the actuator device 500. In particular, this actuator device 500 enables positioning of the pair of clamps 301, 302 in one of the three stable positions Pos1, Pos2, Pos3 by selectively moving the selector beak 306 facing the toothed structure 305.

In the embodiment described here, the actuator device 500 takes the form of an electromechanical device comprising an electrical energy source 501 and an electromechanical actuator 502. The electrical energy source 501 enables delivery of a positive or negative electrical voltage to the electromechanical actuator 502 and therefore enables action on the frame 304 by way of an arm 503 articulated by a flexible guide, in particular pivoting about a virtual rotation axis A503. This arm 503 is connected to the actuator 502 and to the frame 304 by multiple respective elastic structures. In particular, the arm 503 is also inscribed in the monolithic structure 900 and the actuator 502 is designed to be disposed in a housing 504 of the same monolithic structure.

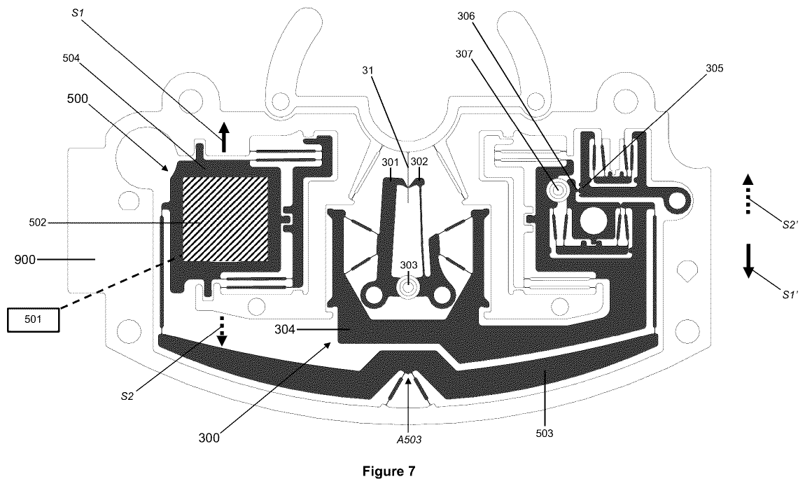

FIG. 7 represents by way of example a view of the elements of the actuator device 500 formed on the structure 900. The latter elements are represented in black, like those of the selector device 300. The actuator 502 is for its part cross-hatched.

The actuator 502 is designed to be actuated in a direction parallel or substantially parallel to the longitudinal direction of the blade 31, in a first sense or a second sense depending on the sign of the electrical voltage delivered by the electrical energy source 501. This voltage is advantageously delivered only periodically so as exclusively to cause the selector beak 306 to be moved relative to the toothed structure 305, the beak being retained in position against the structure 305 because of the effect of the tenon 307 and because of the effect of the various elastic structures whereby the beak 306 may be hooked between two teeth of the toothed structure 305. The various positions are advantageously mechanically stable. Such a design therefore enables minimization of the electrical energy consumption from the electrical energy source 501 for powering of the actuator device 500 but also a comparator device 400 described hereinafter, when present.

The actuator 502 preferably actuates the pair of clamps 301, 302 only when the pair of clamps 301, 302 is in position Pos1 (FIG. 6a), as described hereinafter. In that configuration, the beak 306 is located between two teeth disposed at the center of the toothed structure 305. When the actuator 502 operates in a first sense depicted by a solid arrow S1 in FIG. 7, the beak is driven in a second sense depicted by a solid arrow S1′ and opposite the first sense, given the location of the articulation axis A503 of the arm 503. Such action therefore induces movement of the beak 306 so that the pair of clamps 301, 302 can be positioned in position Pos3 (FIG. 6c). Reciprocally, when the actuator 502 operates in a second sense depicted by a dotted arrow S2 (representing the same direction as the arrow S1′), the beak is driven in a first sense depicted by a dashed arrow S2′ (representing the same sense as the arrow S1) opposite the second sense. Such action therefore induces movement of the beak so that the pair of clamps 301, 302 can be positioned in position Pos2 (FIG. 6b).

The sign of the voltage supplied by the electrical energy 501, and therefore the sense of movement S1, S2 (or S1′, S2′) of the actuator 502 or of the beak 306 depends on a resulting value VD from a comparator device 400. The comparator device 400 may be at least partially electronic. This device enables at least one value VD to be established of the difference between the rotation period P of the mobile 821 and a reference rotation period Pref of said mobile 821 supplied by a counting device 200. The counting device 200 comprises a second oscillator 210 having a frequency F1 significantly higher than the frequency f1 of the first oscillator 100. It may for example be a heat-compensated oscillator having a frequency of the order of several tens or hundreds of kHz or MHz and having excellent stability, which therefore enables definition of a reference rotation period Pref that may be considered as the period that the mobile 821 should ideally have under all circumstances.

In the situation in which the period P substantially corresponds to the period Pref, the electrical energy source 501 does not deliver an electrical voltage and so the actuator 502 does not actuate the pair of clamps 301, 302. The clamps 301, 302 therefore remain retained in position Pos1 (FIG. 6a). In particular the electrical energy source 501 does not deliver an electrical voltage in the situation where:

VD=Pref−P=x,
with x in a predefined tolerance range [a; b] as a function of the required rate of the timepiece.
x is preferably a real number, a is preferably a negative real number, and b is preferably a positive real number.

In the situation where VD<a, the electrical energy source 501 delivers an electrical current with a voltage of a first polarity and so the actuator 501 operates in a first sense so as to cause the pair of clamps 301, 302 to be moved to the position Pos2, which enables the movement to correct a delay displayed by the display element 71.

In the situation where VD>b, the electrical energy source 501 delivers an electrical current at a voltage with a second polarity, opposite the first polarity, so that the actuator 501 operates in a second sense, opposite the first sense, so as to cause the pair of clamps 301, 302 to be moved to the position Pos3, which enables the movement to correct an advance displayed by the display element 71.

Thus, the comparator device 400 is adapted to compare a rotation period P of the mobile 821 of the finishing train 82 and a reference rotation period Pref of said mobile 821.

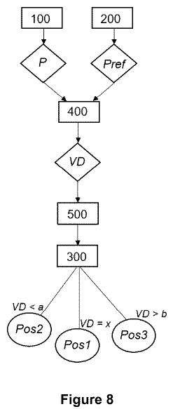

FIG. 8 represents by way of illustration a flowchart summarizing these various situations.

In the embodiment described here, the comparator device 400 comprises a lever 404 and a mobile 401 kinematically coupled to the mobile 821 of the finishing train 82 of the movement 2000. Here the gear ratio is 1:1 and so this mobile 401 also has a rotation period P equal to that of the mobile 821 (equal to or of the order of 60 seconds given that here the mobile 821 is a seconds mobile). The mobile 401 comprises a wheel 402 provided with a tenon 403 designed to cooperate periodically with a lever 404 so as to drive it in rotation against a spring element 405 biased by a lever into a predefined position when the tenon is not in contact with the lever. In particular this lever comprises a beak 404a designed to cooperate with the tenon 403 and an arm 404b designed to come into contact with a pin 406 serving as contactor when the beak 404a is raised by the tenon 403. The loss of contact between the arm 404b and the pin 406 enables determination of the rotation period P at regular or substantially regular intervals (here every minute). This information is then transmitted to an integrated circuit 407 of the comparator device 400 which can be taken into consideration because of the effect of the control device 600.

The control device 600 enables repositioning, in particular periodic repositioning, of the pair of clamps 301, 302 in position Pos1.

In the embodiment described here the control device 600 advantageously enables:
periodic repositioning of the pair of clamps 301, 302 in position Pos1, and
commanding the actuator device 500 in order to enable possible movement of the pair of clamps 301, 302 to position Pos2 or Pos3.

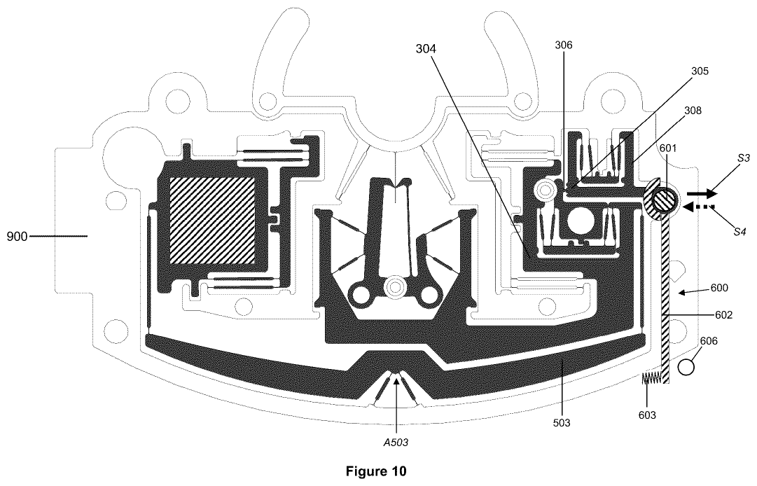

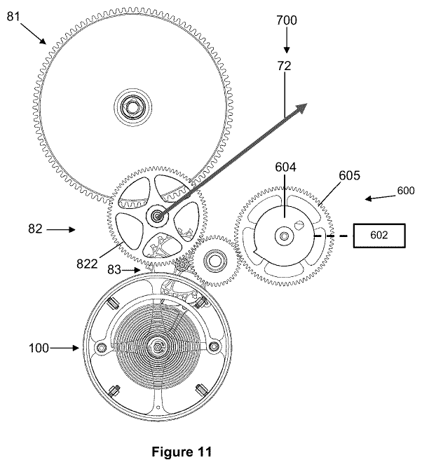

The control device 600 represented in FIGS. 10 and 11 comprises a lever 602 actuated by the finishing train 82 of the movement 2000 and a tenon 601 fixed to the toothed structure 305 of the monolithic structure 900. This lever 602 is designed to act periodically on the tenon 601 so as to retract the selector beak 306 of the toothed structure 305 which is mounted on the structure 900 by way of a flexible structure. In particular, the lever 602 is designed for localized action on the tenon 601 in a direction perpendicular to the direction of the actuator 502 and in a sense S3, which enables the toothed structure 305 to be moved away from the beak 306 and thus the beak 306 to be disengaged from the teeth 305. The beak then returns into position because of the effect of the flexible structures respectively connecting the beak 306 to the frame 304 and the toothed structure 305 to the rest of the structure 900. The pair of clamps 301, 302 returns to position Pos1 because of the specific arrangement and conformation of the various elastic structures.

The lever 602 is more particularly designed to be biased by a spring 603 and to be actuated by a cam 604 mounted on a wheel 605 itself in the form of a branch from the finishing train 82, for example from a center mobile 822 to which is connected an hours hand 72 of the display device 700.

The tenon 601 is also designed to come into contact with a contactor 606 when the lever 602 acts on the tenon 601, which informs the actuator device 500 of the placing of the pair of clamps 301, 302 in position Pos1. This information enables activation of the actuator device 500 and therefore actuation of the selector device 300 taking under consideration the resulting value VD or latest value VD from the comparator device 400.

The control device 600 therefore has the advantage of enabling replacement of the pair of clamps 301, 302 in position Pos1 periodically (in the embodiment described here), without intervention by the actuator device and/or the wearer of the watch. Furthermore, the control device also has the advantage of enabling unitary action of movement of the actuator 502 of given amplitude, whatever the actuation sense (S1, S2). Such a construction therefore enables minimization of the electrical energy consumption from a primary source because the action of the actuator is localized and of predefined amplitude. Such a construction is in particular simpler and more reliable than a construction in which the actuator 502 is required to effect all possible transitions between the three stable positions. Furthermore in the event of non-functioning or failure of the devices 400 and/or 500 the mobile 821 is regulated exclusively by the first oscillator 100, with an elastic return system 10 retained in or returned to position Pos1 because of the effect of the device 600 so that the first oscillator 100 has a nominal frequency f1.

Thus, the mobile 821 can be regulated by the first oscillator 100, independently of the devices 200, 400 in particular.

The control device 600 preferably has the advantage of being integrated into the mechanical or automatic movement 2000, in particular where the elements 601, 602, 603, 604, 605 are concerned.

As a consequence of what has been described above, the control device 600 and/or the actuator device 500 may act on the frequency selector device 300 which is configured so as to define three oscillation frequencies, as follows:
the first frequency f1,
a second frequency f2 lower than the first frequency f1, and
a third frequency f3 higher than the first frequency f1.

In particular, the actuator device 500 acting on the frequency selector device 300 can be controlled by the control device 600.

In order to enable adjustment of a display device 700 comprising in particular the display elements 71 and 72, in particular to enable setting the time, the regulating system 1000 advantageously also comprises a device 800 for initializing the counting device 200 advantageously activated by an adjustment mechanism 91 of the display device 700 of the timepiece 3000, for example an adjustment mechanism integrated into the movement 2000. After setting the time the counting device 200 is therefore initialized in order to take account of the new effective position of the display device 700. The actuator device 500 could advantageously be inhibited for a given period following the action of the initialization device 800.

The monolithic structure 900 is preferably made of monocrystalline silicon. This advantageously enables grouping within it of a large number of elements forming part of the regulating system 1000, in particular the devices 300, 500, 600.

The structure 900 may be designed to be mounted on the frame 6 of the mechanical or automatic movement 2000. The other elements of the regulating system 1000 may also form integral parts of the movement 2000. Alternatively, these other elements, in particular the electronic components, may be arranged at the periphery of the movement 2000 in the timepiece 3000.

The comparator device 400 advantageously acts at intervals of one minute or substantially one minute. A value VD can therefore be established at the same frequency. In the embodiment described here only the value VD established just before or just after contact between the lever 602 and the tenon 606 (which occurs hourly or substantially hourly) is taken into consideration by the actuator 500. The value VD may also be established with any other frequency.

The movement 2000 may advantageously be regulated exclusively by the first oscillator 100 (it is then a mechanical or automatic movement) or by the entire regulating system 1000. The finishing train 82, in particular the mobile 821, is at least partially regulated by the first oscillator 100.

The inertial element 4 of the first oscillator 100 is preferably an assembled balance comprising a balance 41 provided with screws or weights 43a that are movable in order to enable adjustment of the rate of the movement 2000, of the order of a few seconds per day as depicted in FIG. 3. These screws or weights are for example fixed in such a manner as to be movable relative to a felloe 410 of the balance 41. These screws or weights may for example be manipulated by a horologist when the balance is stationary, by way of a key or a screwdriver that enables them to be moved (toward or away from the axis A4). These tools are generally provided with means enabling indication of the advance or the delay of the screw or the weight in order to enable particularly fine adjustment of the rate of the movement.

In the embodiment described here, the felloe 410 of the balance 41 advantageously comprises two pairs of weights 43a, 43b and 44a, 44b having distinct conformations, in particular different masses. The weights 43a, 43b are in particular longer than the weights 44a, 44b. For the same movement along the axis A4 the weights 44a, 44b induce a finer adjustment of the rate than the weights 43a, 43b. The weights are preferably moved in pairs in order to maintain optimum equilibrium of the assembled balance 4.

These weights advantageously enable adjustment of the rate of the movement 2000 over a range ±2 s/d.

Preferably, for a first oscillator 100 that has a nominal frequency of 4 Hz, ksr2=1.1×ksr1 and ksr3=0.9×ksr1, so that the positions Pos2 and Pos3 of the selector device 300 respectively induce an advance and a delay of approximately 10 s/d.

The actuator device 500 and the control device 600 preferably act hourly or substantially hourly on the stiffness selector device 300. It is possible to employ action at any other frequency.

In the embodiment described above the comparator device and the actuator device of the selector device and the control device of the selector device act periodically, namely at regular intervals. Alternatively, the comparator device and/or the actuator device and/or the control device are activated at a particular moment and not necessarily periodically, for example when a control unit deems it appropriate in the event of a rate deviation considered too large. Additionally or alternatively, the wearer of the watch can activate the actuator device if they notice an advance or a delay of the display device of the timepiece. Additionally or alternatively, the actuator device may be a purely mechanical device, controlled for example by the wearer of the watch by means of buttons or correctors.

Regardless of the embodiment or the variant, the control device may impose a nominal oscillation frequency on the mechanical first oscillator after the control unit or the wearer of the watch has intervened, this control device being controlled by the train (at least partly) regulated by the first oscillator.

In an alternative embodiment the actuator device may be activated on command by a control unit or by the wearer. This likewise implies activation of the control device, namely the setting up of the relation between the finishing train and the tenon 601 fixed to the toothed structure 305 of the monolithic structure 900, for example by bringing the lever 602 into contact with the cam 604 because of the effect of an ancillary clutch system. In this particular case, the lever 602 would then be disconnected from the cam 604 when the actuator device is not actuated, for example during conventional functioning of the movement 2000.

In the embodiment described here the comparator device 400 is based on a mobile 401 having a rotation period P equal to that of the mobile 821 of the train 82 of the movement 2000 (equal to or of the order of 60 seconds given that the mobile 821 is in particular a seconds mobile). In this instance the display element or the seconds hand 71 of the display device 700 is not indispensable for correct functioning of the regulating system. Alternatively, the comparator device 400 could be based on the display element or the seconds hand 71 of the display device 700. To this end, the comparator device could comprise means (for example optical means) enabling identification of the effective position of the display element or the seconds hand 71 at a given moment.

In the embodiment described here, modification of the frequency of the mechanical first oscillator involves modification of the stiffness of the elastic return system, in particular modification of the active length of the third elastic return element. It is nevertheless possible to envisage other ways of modifying the frequency of the first oscillator. For example, there may be envisaged modifying the surroundings of the mechanical first oscillator so as to cause variation of the aerodynamic friction to which the oscillating mass of the inertial element is subjected (as in the teaching of the patent CH109521). To this end a fairing could for example be provided to surround the oscillating mass of the inertial element and the conformation of the fairing (its geometry and/or or its disposition on the frame of the movement) could be modified by the effect of the control and/or actuator device(s).

The electromagnetic environment of the mechanical first oscillator may equally be modifiable by the effect of the control and/or actuator device(s) so as to vary its oscillation frequency.

It is equally possible to envisage modification of the inertia of the inertial element by varying the movement of weight elements or weights disposed on the oscillating mass of the inertial element. In this instance, the respective positions of the weight elements or the weights facing the oscillating mass depend on the control and/or actuator device(s). To this end, the weight elements could for example be made of a piezoelectric material or a magnetostrictive material (as in the teaching in the application EP3120199).

More generally, the frequency of the first oscillator may therefore be modified by:
varying the stiffness of the elastic return system of the first oscillator, in particular modifying the active length of an elastic return element of the elastic return system,
varying the inertia of the inertial element of the first oscillator, in particular by movement of weight elements of the inertial element,
varying the aerodynamic and/or electromagnetic environment of the first oscillator.

These techniques may optionally be combined so that the control device modifies the frequency of the first oscillator using a first technique and the actuator device modifies the frequency of the first oscillator using a second technique.

One way of executing an operating method according to the invention is described hereinafter. It is in particular one way of executing a method of operating the regulating system 1000 described above.

The method comprises at least one iteration of the following steps and preferably a plurality of iterations of the following steps, which are executed in sequence:
a first step of operating in a main operating mode in which the mechanical first oscillator 100 oscillates at the predetermined first frequency f1, then
a second step in which the actuator device 500 modifies the frequency of the mechanical first oscillator 100, then
as a consequence of the second step, a third step of operating in an auxiliary operating mode in which the mechanical first oscillator 100 oscillates at the second frequency f2 or the third frequency f3, then
a fourth step in which a control device 600 imposes a return to the main operating mode, this control device 600 being controlled by the train 82 at least partly regulated by the first oscillator 100.

As a consequence of the fourth step, the regulating system executes the first operating step in the main operating mode in which the mechanical first oscillator 100 oscillates at the predetermined first frequency f1.

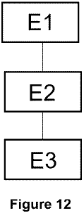

In other words, as depicted in FIG. 12, the method may comprise:
an initialization step E1 occurring at a given moment t1 that enables imposition of a nominal stiffness value ksr1 (implying the frequency f1) of the elastic return system because of the effect of the control device, and further advantageously enables instruction of the actuator device, and
a step E2 of pairing the periods P and Pref made possible by the comparator device at a given time t2 at least, which enables establishing a difference value VD between the periods P and Pref, and
a third step E3 of selecting a predetermined stiffness of the elastic return system from in particular three stiffnesses ksr1, ksr2, ksr3 as a function of the value VD at a given time t3 after t1 and t2 because of the effect of the actuator device of the selector device.

As seen above, the control, comparison and actuator devices preferably act periodically, namely at regular intervals. In other words, these steps are more particularly repeated at regular intervals. For example, the second step E2 is repeated periodically at intervals of one minutes or substantially one minute (first period P1) whereas the first and third steps E1, E3 are repeated periodically hourly or substantially hourly (second period P2).

The method preferably comprises:
a step of comparing the time displayed by the timepiece movement 2000 and a reference time, and
execution of the second, actuation step in the event of a particular threshold being exceeded during the comparison step.

Consequently, the second actuating step may be executed only when the value VD is not in the predefined tolerance range [a; b] mentioned above. The comparison step is advantageously executed by the comparator device 400.

Because of the system described above, the comparison step may be executed at a regular time interval and/or at an interval defined by a timepiece movement 2000, for example at an interval of one minute or one hour. Alternatively, the comparison step may be executed at the request of a user or wearer of the timepiece. To this end, the user can act on a member of the timepiece, such as a button, that activates the comparator device and/or the actuator device.

Because of the system described above the fourth step occurs at a regular time interval and/or at an interval defined by a timepiece movement 2000, for example hourly.

As seen above, the second step may comprise or consist in a step of moving the pair of immobilizing clamps along the elastic blade.

Thanks to the solutions described above a mechanical oscillator can be accelerated or slowed down as a function for example of the effective position of the display device of the watch. In the embodiment described here:
a counting device and another oscillator, for example of the quartz type, enable definition of a reference position of the display device, and
an electronic comparator device enables comparison of the effective and reference positions of the display device,
   so that an electromechanical actuator device is able to select an oscillation frequency of the mechanical oscillator adapted in accordance with loads on the wristwatch, for example.

The solutions described here are remarkable in that they comprise a control device that enables imposition of a predetermined oscillation frequency f1 on the mechanical oscillator thanks to which the timepiece has an intrinsically excellent accuracy. In particular, this control device is controlled by a train, in particular a finishing train, that drives the display device of the watch, which is at least partly regulated by said mechanical oscillator. Furthermore, this control device could equally well be controlled by other means or devices, in particular in the case of a movement in which the correction of the rate is effected upstream of the fourth step occurring at a regular time interval and/or at a defined interval. This control device can therefore be at least controlled by a train, in particular a finishing train.

This control device advantageously enables imposition of a pivoting frequency f1 on the mechanical oscillator, referred to as the “nominal” frequency, that enables adequate functioning of the mechanical oscillator, independently of the other devices 300, 400, 500, 600. Furthermore, in the embodiment described here this control device also has the advantage of enabling selection of at least one other oscillation frequency (f2, f3) of the mechanical oscillator by instructing the actuator device to select at least one other oscillation frequency.

In order to improve the rate of the timepiece, the regulating system comprises a mechanical oscillator the nominal frequency of which can be modified, possibly at regular intervals, but can be re-established, possibly at regular intervals, because of the effect of a control device controlled by a train, in particular a finishing train, that is at least partly regulated by said mechanical first oscillator. By “nominal” frequency (f1) is meant a frequency of the mechanical first oscillator determined at the design stage and/or during assembly of said first oscillator in order to achieve a target chronometric accuracy when the train, in particular the finishing train, is regulated exclusively by said first oscillator. Assembly of the first oscillator may for example require a targeted adjustment of the stiffness, in particular of the active length, of a return element of the elastic return system forming part of the first oscillator or a targeted adjustment of weights disposed on an inertial element that is part of the first oscillator. The frequency f1 of the system is a frequency such that the timepiece movement and/or the timepiece can be certified, in particular to obtain a chronometer certification by the COSC (Contrôle Officiel Suisse des Chronomètres), or even such that the timepiece can obtain the “superlative chronometer” certification of the applicant. These certifications can therefore be obtained independently of the use of the solutions described above in which the movement functions during certain periods with a frequency of the first oscillator different from the frequency f1.

The solutions described here are distinguished in particular from the documents EP1158373 and EP1164441 by the fact that the regulating system comprises a mechanical first oscillator the frequency f1 of which can be modified (by the actuator device of the selector device) but is then re-established (by the control device of the selector device), in particular re-established autonomously by an element actuated directly by the finishing train.

The solutions described here are distinguished in particular from the documents CH6444 and CH321947 by the fact that the control device enables imposition of a predetermined frequency on the mechanical oscillator, this device being controlled by a train, in particular the finishing train, coupled to a display device of the watch, which is at least partly regulated by said mechanical oscillator and not by a third-party device or by the wearer of the watch.

1. A regulating system comprising:
a mechanical first oscillator designed to regulate at least partly a train of a timepiece movement driven by a drive system,
a control device configured to impose a main operating mode in which the mechanical first oscillator oscillates at a first predetermined frequency, the control device being controlled by a train at least partly regulated by the first oscillator, and
an actuator device configured to command passage to an auxiliary operating mode in which the mechanical first oscillator oscillates at another predetermined frequency different from the first frequency.

2. The system as claimed in claim 1, wherein the regulating system comprises a frequency selector device and the control device and/or the actuator device act(s) on a frequency selector device configured so as to define three oscillation frequencies, as follows:
the first frequency,
a second frequency lower than the first frequency, and
a third frequency higher than the first frequency.

3. The regulating system as claimed in claim 1, wherein the mechanical first oscillator comprises an inertial element and an elastic return system and the three oscillation frequencies are defined by respective predetermined stiffnesses of the elastic return system.

4. The regulating system as claimed in claim 3, wherein the selector device comprises a pair of clamps determining an active length of the elastic return system.

5. The regulating system as claimed in claim 2, wherein the actuator device acting on the selector device is controlled by the control device.

6. The regulating system as claimed in claim 1, wherein the regulating system comprises a comparator device adapted to compare a period of rotation of a mobile of a finishing train and a reference rotation period of said mobile.

7. The regulating system as claimed in claim 1, wherein the regulating system comprises a counting device including a second oscillator with a fourth frequency greater than the first frequency.

8. The regulating system as claimed in claim 7, wherein the regulating system comprises a device for initializing the counting device configured to be activated by an adjustment mechanism of a display device of a timepiece.

9. A timepiece movement comprising:
a regulating system as claimed in claim 1, and
a train.

10. A timepiece comprising a regulating system as claimed in claim 1.

11. A method of operating a regulating system for a timepiece movement, the regulating system comprising a mechanical first oscillator designed to regulate at least partly a train of a timepiece movement driven by a drive system, the method comprising at least one iteration of the following actions:
operating in a main operating mode in which the mechanical first oscillator oscillates at a predetermined first frequency,
modifying, by an actuator device, a frequency of the mechanical first oscillator,
operating in an auxiliary operating mode in which the mechanical first oscillator oscillates at a second frequency or at a third frequency,
imposing, by a control device, return to the main operating mode, the control device being controlled by the train at least partly regulated by the first oscillator.

12. The operating method as claimed in claim 11, wherein the method comprises:
comparing a time displayed by a timepiece movement and a reference time, and
carrying out the modifying by the actuator device if a particular threshold if exceeded during the carrying out of the comparing.

13. The operating method as claimed in claim 12, wherein the comparing is carried out at a regular time interval and/or at an interval defined by a timepiece movement.

14. The operating method as claimed in claim 12, wherein the comparing is carried out upon a request by a user.

15. The operating method as claimed in claim 11, wherein the imposing by the control device is carried out at a regular time interval and/or at an interval defined by a timepiece movement.

16. The operating method as claimed in claim 11, wherein the modifying by the actuator device comprises moving a pair of immobilization clamps along an elastic blade and/or wherein the imposing by the control device comprises moving a pair of immobilization clamps along an elastic blade.

17. The regulating system as claimed in claim 4, wherein the pair of clamps determine three active lengths of the elastic return system.

18. The timepiece movement as claimed in claim 9, wherein the train is a finishing train.

19. The regulating system as claimed in claim 2, wherein the mechanical first oscillator comprises an inertial element and an elastic return system and the three oscillation frequencies are defined by respective predetermined stiffnesses of the elastic return system.

20. The regulating system as claimed in claim 19, wherein the selector device comprises a pair of clamps determining an active length of the elastic return system.
